(19) United States
(12) Patent Application Publication
(10) Pub. No.: US 2020/0369186 A1
(43) Pub. Date: Nov. 26, 2020

(54) Automatic Displacement Device for Carrier, and Method of Operating the Device

(71) Applicant: TRON ENERGY TECHNOLOGY CORP LTD, Taoyuan City (TW)

(72) Inventor: Chia-Ming Chuang, Taoyuan City (TW)

(21) Appl. No.: 16/636,559

(22) PCT Filed: Aug. 14, 2018
(86) PCT No.: PCT/CN2018/100341

§ 371 Date: Feb. 4, 2020

(30) Foreign Application Priority Data
Aug. 18, 2017 (CN) 201710711054.2

(51) Int. Cl. B60N 2/427; B60N 2/00; B60R 21/015; B60R 16/037

(52) U.S. Cl. CPC B60N 2/42736; B60R 16/037; B60R 21/01516; B60N 2/002

(57) ABSTRACT

An automatic displacement device for use in a carrier includes at least one weight mount, at least one actuator, and at least one stability regulator. The weight mount can hold at least one heavy object accommodated in the carrier' body. The actuator is coupled to the weight mount. The stability regulator is electrically communicated to the actuator and includes a sensor and a controller. The sensor can measure a state associated with an angle of the carrier's body and output a signal representative of the state. The controller calculates a tilt of the carrier according to the signal outputted from the sensor and is capable of commanding the actuator to move the weight mount in view of the tilt to perform a compensation on the carrier.

### FIELD OF THE INVENTION

The present invention relates to an automatic displacement device for use in a carrier and, more particularly, to an automatic displacement device that can move a heavy object accommodated in the carrier.

### BACKGROUND OF THE INVENTION

Traffic safety has always been one of the core issues of transportation. Vehicles should guarantee that passengers and cargo thereon to arrive the destination without damages. According to Fatal Accident Reporting System (FARS) Data, National Highway Traffic Safety Administration (NHTSA), rollover is the most hazardous type of single-vehicle accidents and the leading cause of roadside fatalities, which may account for 33.8 percent of roadside fatalities.

Thus, to reduce the risk of traffic accidents and increase driving safety, impacts and rollovers of vehicles should not be ignored. The main cause of rollover accidents is that all torques acting on a vehicle are unbalanced. There are many factors affecting the stability of driving a vehicle, such as the gravity center height of the vehicle, the inertia or velocity of the vehicle when cornering, external forces acting on the vehicle, and road conditions such as radius of curvature, wetness, bank (ramp). To predict vehicle rollover propensity, the static stability factor (SSF) of a vehicle, which is defined as the track width of the vehicle divided by twice the height of the gravity center above the ground, is commonly used. The greater the SSF value, the larger is the critical tilt angle of the vehicle (beyond which the vehicle would roll over onto its side), and the less likely the vehicle is to roll over.

It is difficult for vehicles to achieve traffic safety through weight design. Large transportation equipment, such as buses, trucks, and trailers, is usually designed to have a high gravity center, not to mention ships. For large transportation equipment, when passengers or goods are accommodated, the height of the gravity center of the transportation equipment would become even higher. For small cars, the driver seat is usually designed to have a sufficient height to improve the vision and comfort for the driver, which leads to an increase in the height of gravity center. However, transportation equipment of high gravity center is at risk of rollovers.

In the last few years, there has been a trend of electrification in vehicles. Electric vehicles, which employ electrically driven devices, such as motors, instead of internal combustion engines, are in line with the trend of green travel today. In general, electric vehicles are battery powered, wherein the battery pack, composed of multiple cells, accounts for about 30% of total vehicle weight. Thus, the way of arranging a battery pack in a vehicle can affect the safety of driving the vehicle. For large electric buses, to increase the compartment space for accommodating more passengers, batteries have been considered to be located on the top of a bus. However, this also causes the buses to suffer rollovers easily.

There are several researches on automatic driving technique, as shown in FIG. 1, wherein a distance/velocity sensor 94 is provided on a vehicle 9 to detect surrounding objects 95, so that warning or automatic braking action can be provided as soon as an obstacle or person close to the vehicle is detected. In addition, a suitable brake force on each wheel of the vehicle can be applied according to the individual wheel. The sensor 94 can be used to prevent a vehicle from moving faster than a critical velocity, yet in many traffic accidents, there are causes other than the velocity and acceleration of the vehicle itself, for example: external forces applied to the vehicle, road conditions such as accumulated snow or large animals. Also, the sensor 94 is unable to prevent the vehicle from slipping sideways or tipping. According to the National Highway Traffic Safety Administration, 95% of vehicle rollover accidents can be ascribed to external factors, such as traffic violations caused by other drivers.

According to the statistics of Taiwan Transport Safety Website Information System, vehicle crashes account for the majority of traffic accidents. It is possible for a vehicle to prevent crashes through measurement of distance and velocity relative to an object, as in ADAS (advanced driver-assistance systems) widely discussed these days. Additionally, vehicle-to-vehicle (V2V) wireless communication can be implemented to reduce crashes. Theoretically, sensor technology can be collaborated with the brake system and even the power system of an automatic driving vehicle to reduce crashes. However, there is no technology that can avoid crashes completely.

One of the risks that cannot be eliminated is that the vehicle with a sensing function has no time to react, which exists in both manually operated vehicles and automatically controlled vehicles. Once the braking system cannot effectively stop the vehicle, or if the vehicle faces a high-speed oncoming object and not enough space exists therebetween, the passengers, the cargo or even the battery in the vehicle may directly or indirectly be affected by the energy transferred from an impact, and thus suffer damages.

Besides, the use of inter-communication between vehicles (V2V system), or signal exchange between a vehicle and its surrounding objects (V2X system) cannot completely avoid impact accidents. V2V systems require consumers to pay additional costs. Currently, there are not many vehicles installed with V2V systems. Also, many surrounding objects, such as trees on a roadside or elks on a road, are unable to communicate with a vehicle with a V2V system. Therefore, despite the advent of the V2V system, the traffic accidents cannot be eliminated completely.

In view of the foregoing, there is an urgent need to provide a solution that can increase the critical tilt angle of a vehicle to reduce rollover propensity thereof. When a rollover is inevitable, safety measures on the passengers, cargoes, or battery packs on the vehicle can be offered so that damages can be reduced.

### SUMMARY OF THE INVENTION

One object of the present invention is to provide an automatic displacement device for a carrier, which can move a weight mount in the carrier to shift the gravity center of the carrier so as to improve the stability of the carrier.

Another object of the present invention is to provide an automatic displacement device for a carrier, which can move a weight mount in the carrier to shift the gravity center of the carrier so as to increase the critical tilt angle of the carrier.

A further object of the present invention is to provide an automatic displacement device for various carriers, which employs a stability regulator electrically communicated to an actuator that is coupled to a weight mount, so as to enhance the safety of the carrier.

A still further object of the present invention is to provide an automatic displacement device for a carrier, which employs a stability regulator electrically communicated to an actuator that is coupled to a weight mount, to reduce the use of emergency braking and to provide comfort for the driver in driving the carrier.

A yet still further object of the present invention is to provide an automatic displacement device for a carrier, which makes use of sensors, actuators, weight mounts available from the market, to increase the safety of the carrier yet with economic cost.

A yet still further object of the present invention is to provide a method applied to an automatic displacement device for a carrier, so that an actuator can move a weight mount in the carrier so as to increase the stability and maneuverability and safety of the carrier without relying on networking technology of vehicles or things.

A yet still further object of the present invention is to provide a method applied to an automatic displacement device for a carrier, so that an actuator can move a weight mount in the carrier to provide additional buffer space for the passengers or the battery pack in the carrier, thus reducing damages.

The automatic displacement device of the present invention can be implemented in a carrier having a body that accommodates at least one heavy object. The automatic displacement device comprises at least one weight mount, at least one actuator, and at least one stability regulator. The weight mount can hold the heavy object. The actuator is coupled to the weight mount. The stability regulator is electrically communicated to the actuator and includes a sensor and a controller. The sensor can measure a state associated with an angle of the carrier's body and output a signal representative of the state. The controller calculates a tilt of the carrier according to the signal outputted from the sensor and is capable of commanding the actuator to move the weight mount in view of the tilt to perform a compensation on the carrier.

With the automatic displacement device, the passengers or the battery pack in the carrier, which serves as heavy objects, can be moved together with the weight mount to shift the gravity center of the carrier so that the carrier can perform cornering more easily, thus improving the maneuverability and safety of the carrier. When an impact or rollover is inevitable, the passengers can be moved away from the estimated impact point to provide additional buffer space therefor, and thus to reduce damages without incurring much expense.

### BRIEF DESCRIPTION OF THE DRAWINGS

FIG. 1 shows a schematic view of a carrier installed with a sensor according to a prior art.

FIG. 2 shows a 3-dimensional schematic view of a first embodiment of the present invention, wherein an automatic displacement device is implemented in a small general-purpose car.

FIG. 3 shows a 3-dimensional schematic view of the automatic displacement device shown in FIG. 2.

FIG. 4 shows a flowchart to illustrate a method applied to the automatic displacement device shown in FIG. 2.

FIG. 5 shows a 3-dimensional schematic view of a second embodiment of the present invention, wherein an automatic displacement device is implemented in an electric bus.

FIG. 6 shows a 3-dimensional schematic view of the automatic displacement device shown in FIG. 5.

FIG. 7 shows a front schematic view of the second embodiment, wherein the electric bus is driving on a straight road.

FIG. 8 shows a front schematic view of the second embodiment, wherein the electric bus is driving on a curved road.

FIG. 9 shows a flowchart to illustrate a method applied to the automatic displacement device shown in FIG. 5.

FIG. 10 shows a 3-dimensional schematic view of a third embodiment of the present invention, wherein an automatic displacement device is implemented in a ship.

FIG. 11 shows a schematic sectional view of the ship shown in FIG. 10.

FIG. 12 shows a flowchart to illustrate a method applied to the automatic displacement device shown in FIG. 10.

FIG. 13 shows a 3-dimensional schematic view of a fourth embodiment of the present invention, wherein an automatic displacement device is implemented in an electric recreational car.

FIG. 14 shows a 3-dimensional schematic view of the automatic displacement device shown in FIG. 13.

FIG. 15 shows a diagram for parts of the automatic displacement device shown in FIG. 13.

FIG. 16 shows a flowchart to illustrate a method applied to the automatic displacement device shown in FIG. 13.

FIG. 17 shows a 3-dimensional schematic view of a fifth embodiment of the present invention, wherein an automatic displacement device is implemented in a truck.

FIG. 18 shows a diagram for parts of the automatic displacement device shown in

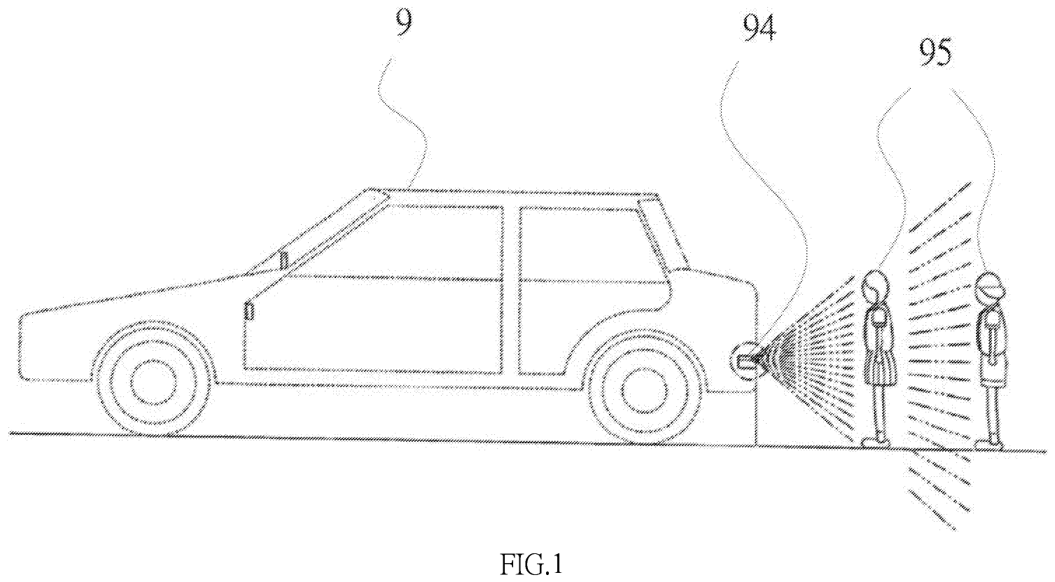

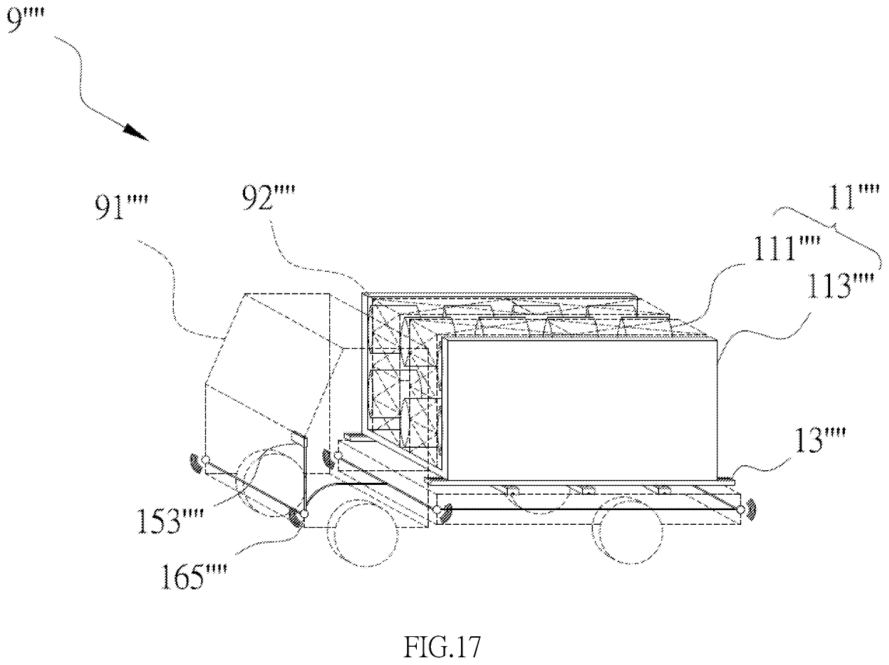

FIG. 17.

FIG. 19 shows a flowchart to illustrate a method applied to the automatic displacement device shown in FIG. 17.

The foregoing and other features and advantages of illustrated embodiments of the present invention will be more readily apparent from the following detailed description, which proceeds with reference to the accompanying drawings.

### DETAILED DESCRIPTION OF THE ILLUSTRATED EMBODIMENTS

The foregoing and other technical contents, features and advantages of the present invention will be illustrated in detail by way of exemplary embodiments with reference to the accompanying drawings. In the exemplary embodiments, same elements will be indicated by similar numerals or labels. In the present invention, a carrier means a piece of transportation equipment, such as a vehicle or a ship, which can take objects therein.

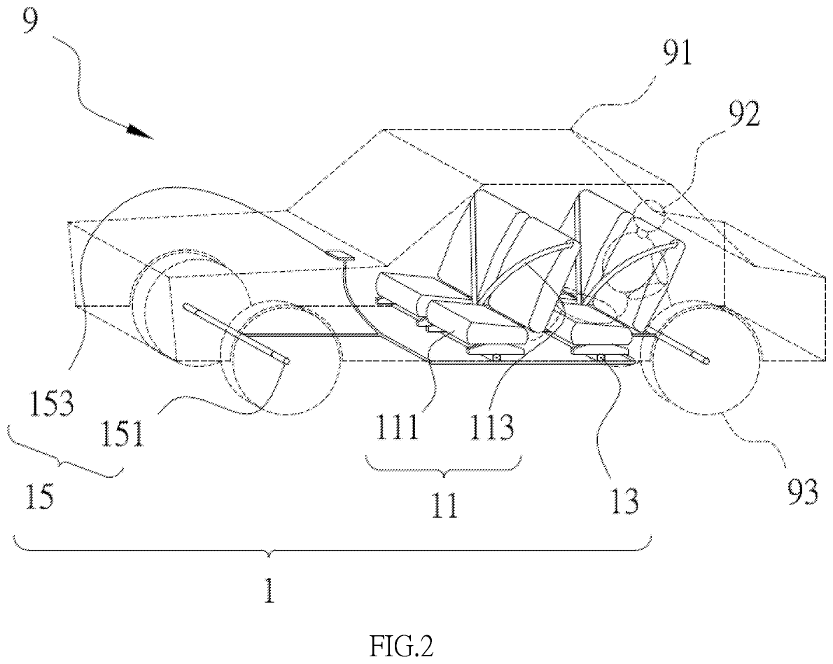

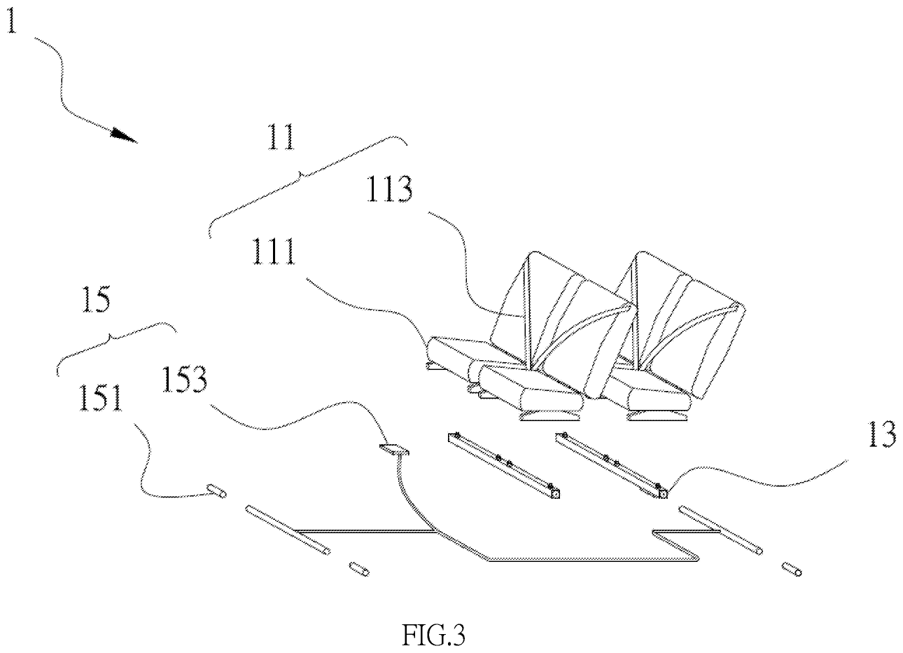

Referring to FIGS. 2 and 3, an automatic displacement device for use in a carrier according to a first embodiment of the present invention is shown, wherein the carrier is a small general-purpose car. The automatic displacement device 1, which generally includes a weight mount 11, an actuator 13, and a stability regulator 15, is installed in the body or housing 91 of the car. In this embodiment, the passengers in the car are chosen as heavy objects 92. To shift the gravity center of the car in maximum extent, the passenger seats are separated from the driver seat in structural connection. The weight mount 11, which refers to the passenger seats, includes a support component 111 and a buffer component 113. The support component 111 refers to the base portion and the back portion of a seat, which bears the weight of a passenger. The buffer component 113 refers to the safety belt of a seat. The actuator 13 can employ a screwed shaft together with sliding rails and brackets (not shown). For example, one end of the screwed shaft is disposed under the support component 111, whereas another end of the screwed shaft is connected to the body of the car. As such, the weight mount 11 can be moved easily to change the gravity center of the car, without causing much friction. Of course, those skilled in the art can understand that other forms of the actuator, such as the one with hydraulic or pneumatic elements, can also be used without hindering implementation of the present invention.

Referring again to FIGS. 2 and 3, the stability regulator 15 includes a sensor 151 and a controller 153. The controller 153 is illustrated as a micro-controller of the car. The sensor 151 includes four force-measuring elements formed of resistances, which can be installed at the shock absorbers of the four wheels. The force measuring element installed at each wheel can send a signal representative of the measured force to the micro-controller via CAN bus. Through the forces measured at the wheels, an angle or weight distribution on the wheels of the car can be measured.

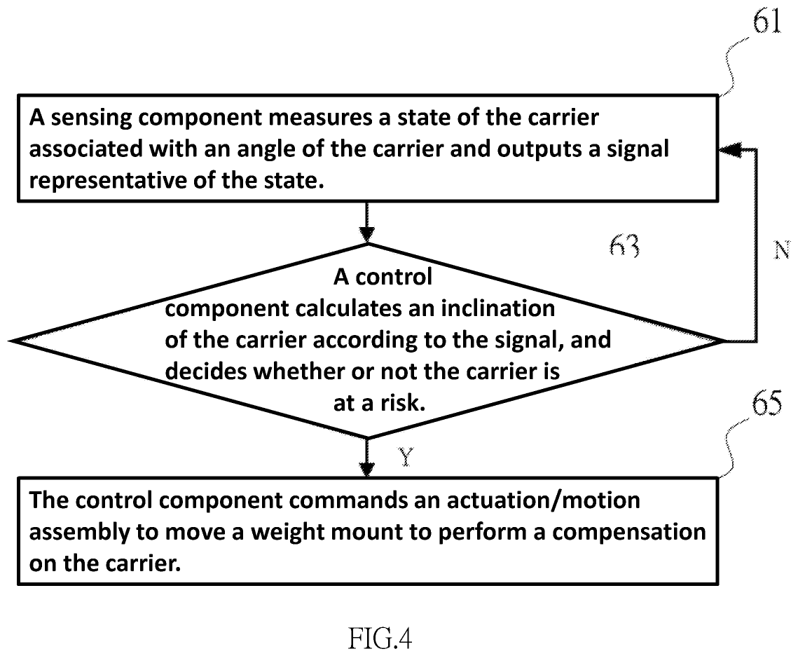

FIG. 4 shows a flowchart to illustrate an application of the automatic displacement device according to the first embodiment, wherein the car is about to turn left at a high speed. In step 61, the sensor 151 can output signals each representative of the force measured at one wheel to the controller 153. In step 63, the controller 153 calculates the tilt of the car according to the signals outputted from the sensor 151. If the velocity or inertia of the car is too high for the tilt, then step 65 will be executed, wherein the controller 153 can issue a command to the actuator 13 to move the weight mount 11 (i.e. the front and rear passenger seats) towards the left side of the car. As a result, the centripetal forces required for turning the car around the curve of the road can be reduced, thus improving the safety of the car. Of course, the buffer component 113 can be an object made of foam materials, or an airbag.

In addition, according to the measurement of the loads shared by the wheels, the controller 153 can issue a command to the actuator 13 so as to change the location of the passenger seats. Consequently, the gravity center of the carrier's body 91 can be shifted so as to compensate for the unequal shared load on the wheels or the tilt of the carrier. Therefore, each wheel 93 can share the same load to avoid uneven wear of tire and to increase the critical tilt angle of the carrier to deter a potential rollover, thus improving stability and comfort in driving the carrier. In particular, with the automatic displacement device of the present invention, the use of emergency braking can be reduced. Even if emergency braking is inevitable, the car can be prevented from going out of the road, thus increasing the safety, stability maneuverability, and comfort of the car. Of course, those skilled in the art can understand that other types of controllers, such as tracking controllers or ABS controllers can also be used or incorporated

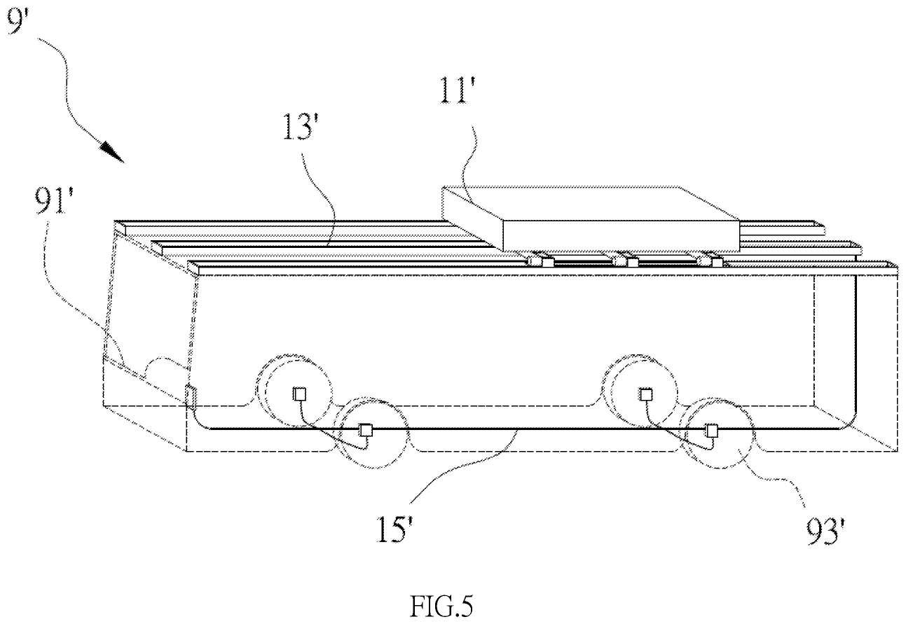

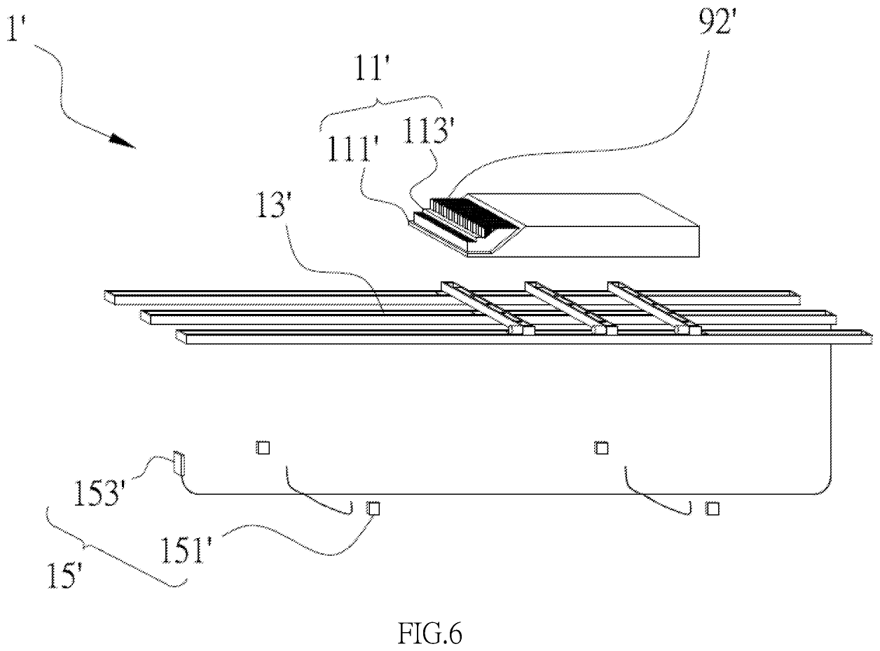

Also, the carrier of the present invention is not limited to a small general-purpose car, other transportation equipment, such as trucks, electric cars, buses, and ships, can also employ the automatic displacement device. FIGS. 5 and 6 show a second embodiment of the present invention, wherein the carrier 9′ is an electric bus. Because the number of passengers and their locations are unknown, the battery pack composed of thousands of cell and having a weight amounted to 30% of the bus, rather than the passengers, is chosen as a heavy object 92′.

Generally, if a battery pack is located on top of a bus, the gravity center of the bus will raise, which leads to difficulty in driving the bus and may decrease the safety of the bus. Contrary to the general fact, the battery pack of this embodiment is provided on top of the carrier's body 91′. Furthermore, the actuator 13′ is configured to include a sliding rail system arranged on a horizontal plane, so that the weight mount 11′ together with the battery pack can be moved horizontally in x-direction or y-direction. The support component 111′ of the weight mount 11′ refers to a cooling box, whereas the buffer component 113′ refers to the heat-dissipation resin material, which is put in the cooling box to alleviate the impact effect on the battery pack.

The sensor 151′ includes an inertial sensing unit, such as a 3-axis G-sensor (gravitational sensor), installed at the carrier's body 91′, which can measure accelerations of the carrier in three directions and output signals representative of the accelerations. The controller 153′ can receive the signals outputted from the sensor 151′ to calculate a tilt or inclination of the carrier 9′, so that a necessary compensation or corrective action on the carrier can be performed. For example, when most passengers are located near the front door (front right corner) of the bus, the stability regulator 15′, which includes the sensor 151′ and the controller 153′, can issue a command to the actuator 13′ to move the battery pack towards the rear left corner of the bus, so that the gravity center of the bus can be maintained at its original location, thus facilitating maneuver of the bus and increasing the safety of the bus. Also, each wheel 93′ bears substantially the same load, thus increasing the service life of the wheels 93′. With the automatic device, the problem of high gravity center resulting from the battery pack placed on top of the bus can be solved. This makes a low-chassis bus feasible, and also makes the space utilization of the bus increase as well.

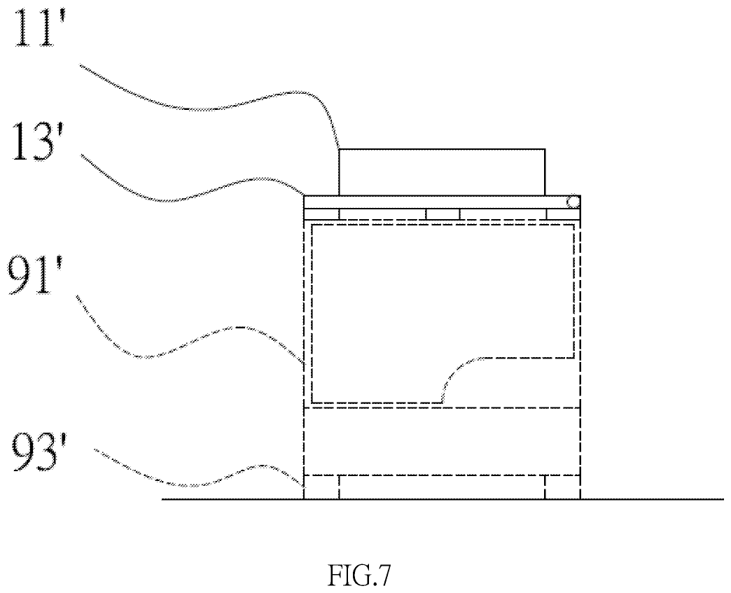

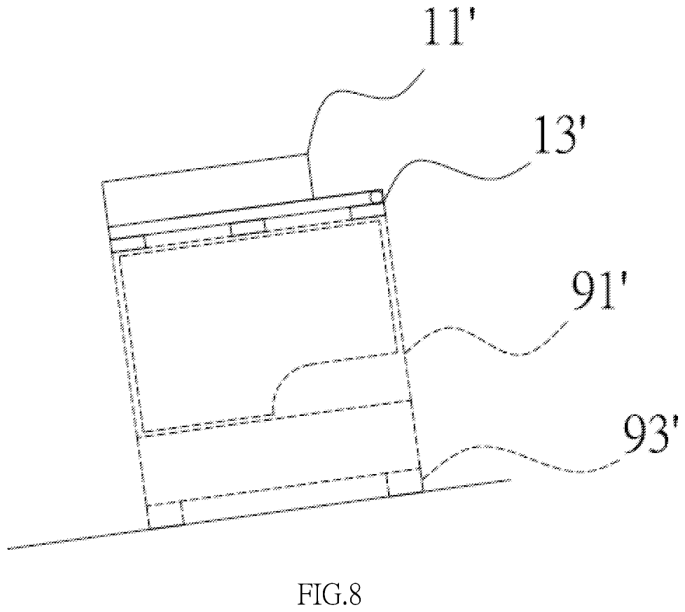

FIGS. 7 and 8 show an application of the second embodiment, wherein the electric bus moves at a high speed and is about to take a right turn. After calculating the tilt of the bus according to the signals provided by the sensor 151′, the controller 153′ may issue a command to the actuator to move the weight mount 11′ on top of the bus's body 91′ towards the right side to facilitate the bus turning right. Otherwise, due to the excessive inertia, the bus may go out of the road or even roll over. In addition, when the bus goes uphill or downhill, the weight mount 11′ can be moved towards the front end or rear end of the bus to increase the stability of the bus.

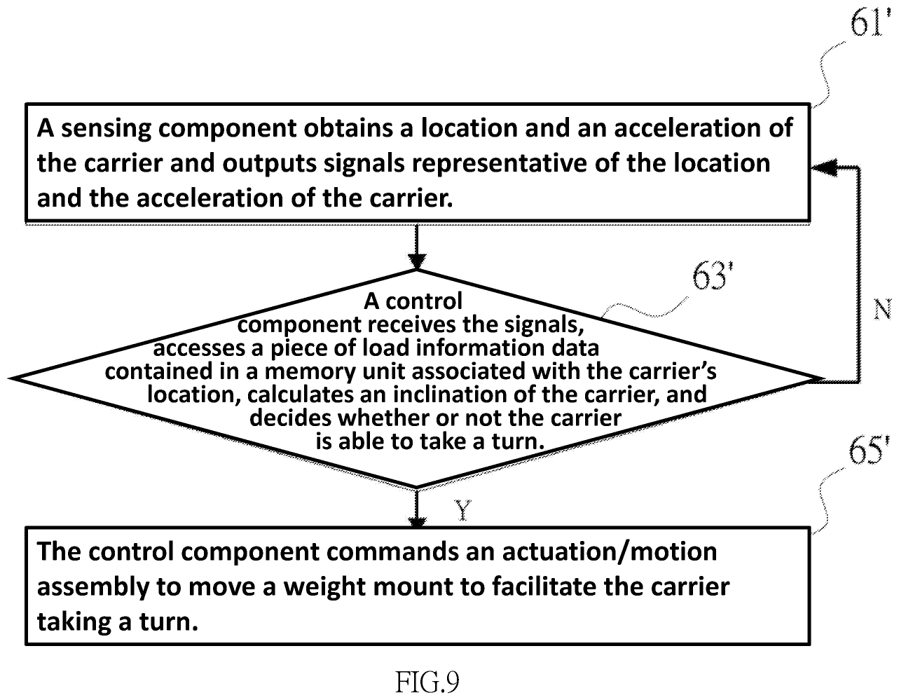

The sensor 151′ may further include a position determination unit, such as a GPS receiver. In addition, with modern communication technology, the controller 153′ can be easily offered an ability to get real-time weather data. Suppose the electric bus runs along a certain route. When the controller is informed that the destination station is going to have snow or sleet, the driver can make preparation in advance to overcome possible troubles. FIG. 9 shows a flowchart to illustrate an application of the automatic displacement device according to the second embodiment. In step 61′, the sensor 151′ is configured to send location data of the carrier 9′ as well as accelerations measured by the G-sensor, which are associated an angle of the carrier 9′. In step 63′, the controller 153′ calculates a tilt or inclination of the carrier according to the accelerations from the sensor 151′. Also, the controller 153′ accesses the road information according to the location data of the carrier 9′, and thus can remind the driver of reducing speed if the road information shows a curved road being about to enter. Also, if the controller 153′ decides that the road is unable to provide adequate centripetal force for the carrier 9′, then step 65′ will be executed, wherein the controller 153′ can issue a command to the actuator 13′ to move the weight mount 11′ together with the heavy objects 92′ so that the gravity center of the bus can be shifted so that the carrier 9′ can take a turn more easily. Therefore, the stability and safety of the carrier 9′ can be maintained.

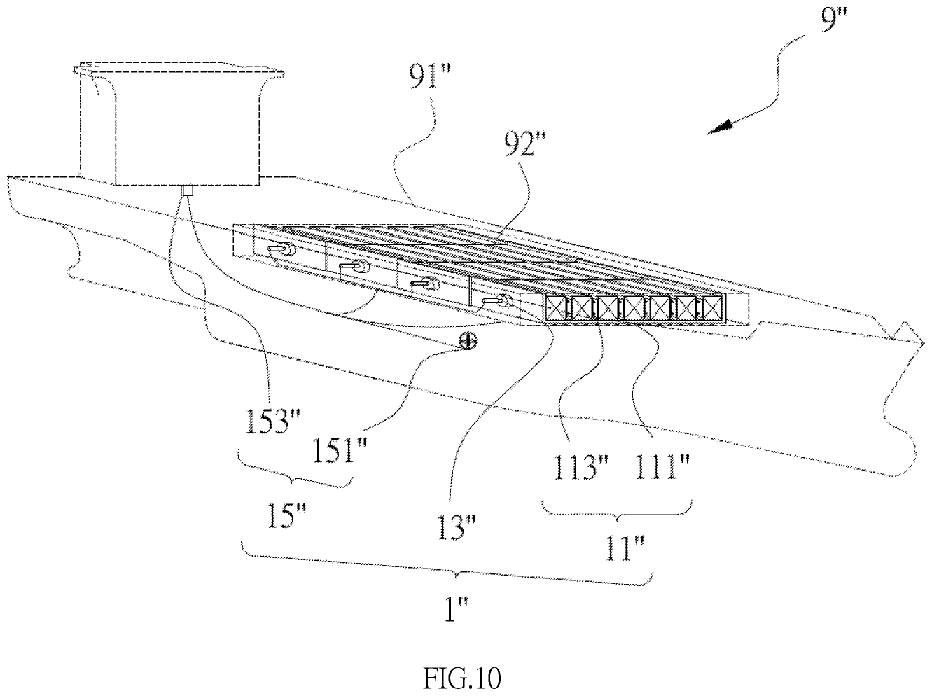

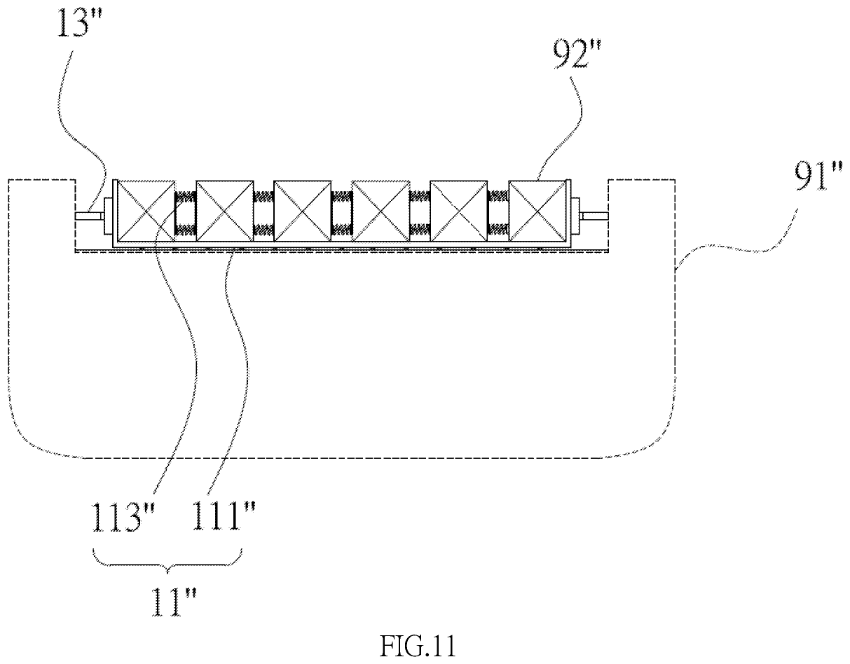

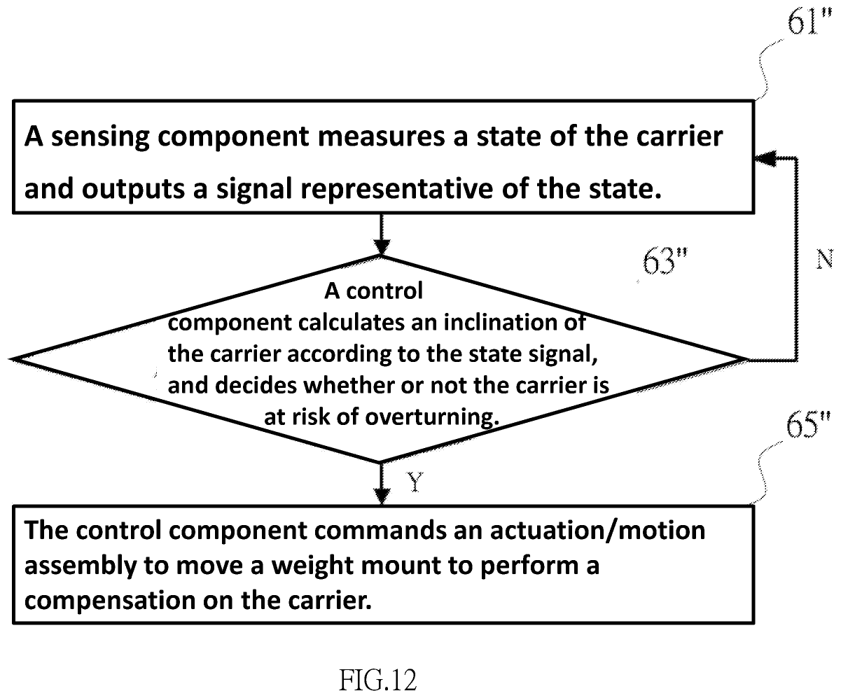

FIGS. 10 through 12 show a third embodiment of the present invention, wherein the carrier 9″ is a ship, and the automatic displacement device 1″ is installed on the body 91″ of the ship 9″. In this embodiment, the heavy objects 92″ refer to the containers of the ship, which are held and protected by the weight mount 11″ including the support component 111″ and the buffer component 113″. The support component 111″ is in the form of a platform for carrying the containers, and the buffer component 113″ is in the form of spring plates arranged between the containers. The actuator 13″ can employ a hydraulically operated rail system to move the containers of the ship. The sensor 151″ includes a 3-axis G-sensor unit or a gyroscope. FIG. 12 shows a flowchart to illustrate an application of the automatic displacement device according to the third embodiment. In step 61″, the sensor 151″ is configured to sense a state of the ship (acceleration or angular rate). In step 63″, the controller 153″ calculates a tilt or inclination of the ship according to the state signal measured by the sensor 151″; if the ship is at risk of a rollover in view of the tilt, then step 65″ will be executed, wherein the controller 153″ can issue a command to the actuator 13″ to move the weight mount 11′ together with the heavy objects 92″ so that the rollover propensity of the ship can be reduced. Therefore, the ship can be prevented from rolling over.

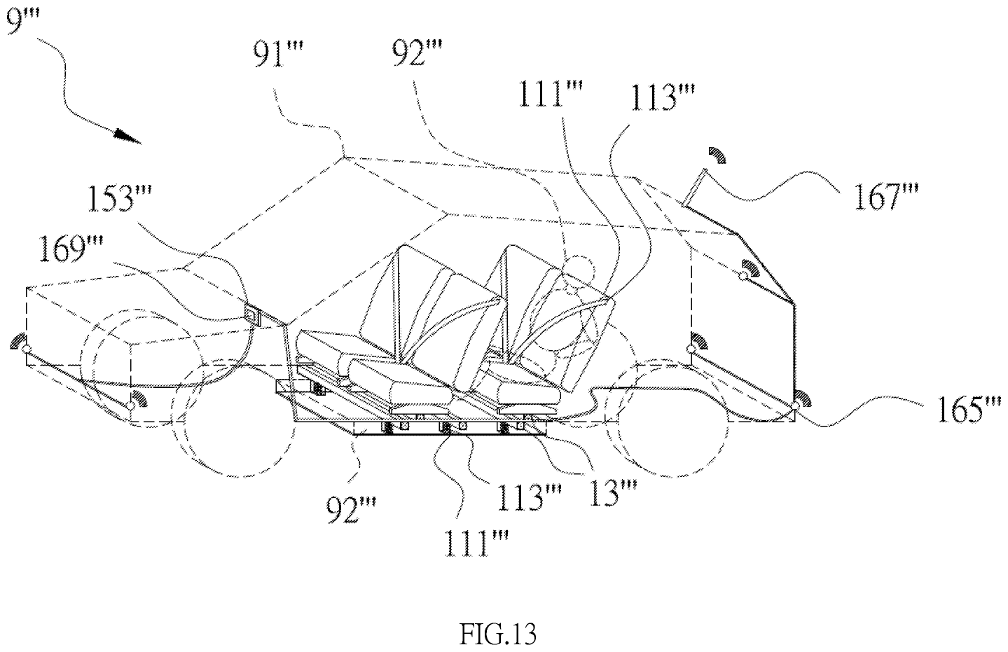

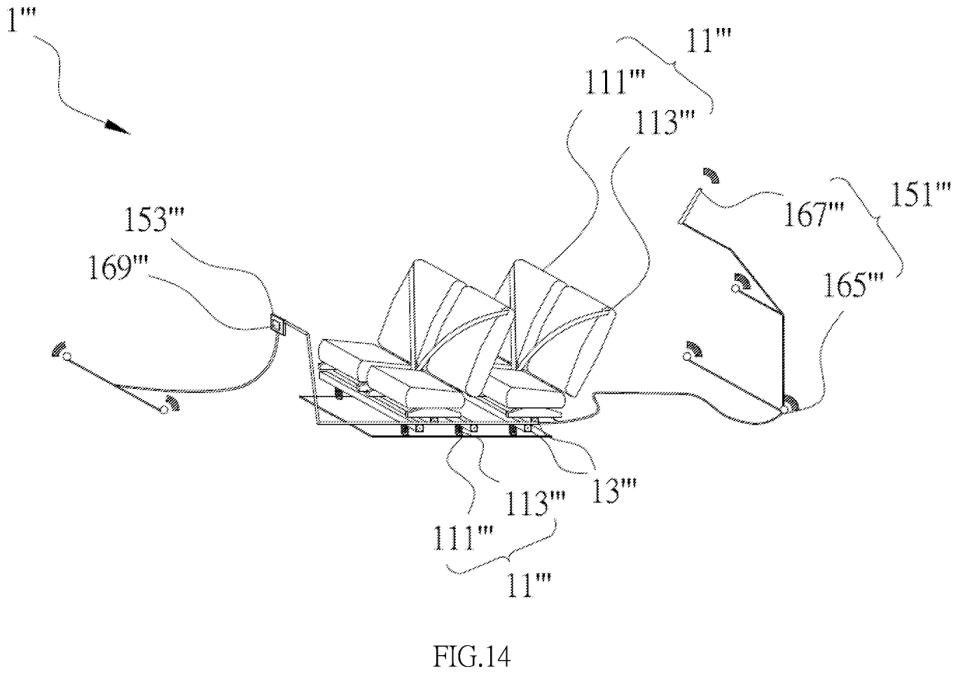

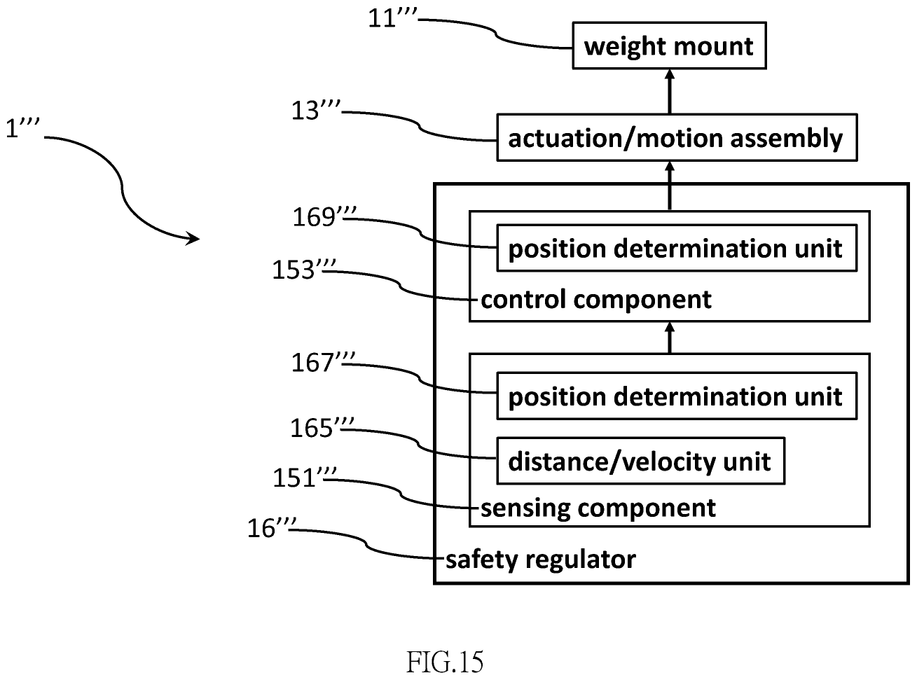

Those skilled in the art can understand that the automatic displacement device of the present invention is not limited to an application for keeping a carrier in equilibrium. Other applications for restraining damages in accidents can also use the automatic displacement device. FIGS. 13 through 15 show a fourth embodiment of the present invention, wherein the carrier is an electric recreational car having a body 91′″. In addition to the passengers, the battery pack can be chosen as the heavy objects 92′″, because batteries, when suffering impacts, are prone to cause short circuits, and even worse such as burning or exploding up.

In this embodiment, the weight mount 11′″ includes support components 111′″, including passenger seats and a battery suspending device, and buffer components 113′″, including safety belts for the passenger seats and spring plates for the battery pack. The weight mount 11′″ can be connected to the actuator through bolts or welding.

On the other hand, the safety regulator 16′″, which is electrically communicated to the actuator 13′″, includes a sensor 151′″ and a controller 153′″. The sensor 151′″ includes a distance/velocity measurement unit 165′″ and a position determination unit 167′″. The distance/velocity measurement unit 165′″ may employ a light emission/return measurement technique, as used in lidar (light wave radar) sensors, which can measure a distance of the carrier 9′″ relative to a surrounding object by emitting a beam of light and receiving light reflected by the surrounding objects. The position determination unit 167′″ can be a GPS receiver, by which the location of the carrier 9′″ can be determined. The controller 153′″ can receive all signals sent from the sensor 151′″. Of course, those skilled in the art can understand that distance/velocity measurement can also be achieved by other ways, such as radar sensors, without hindering the implementation of the present invention.

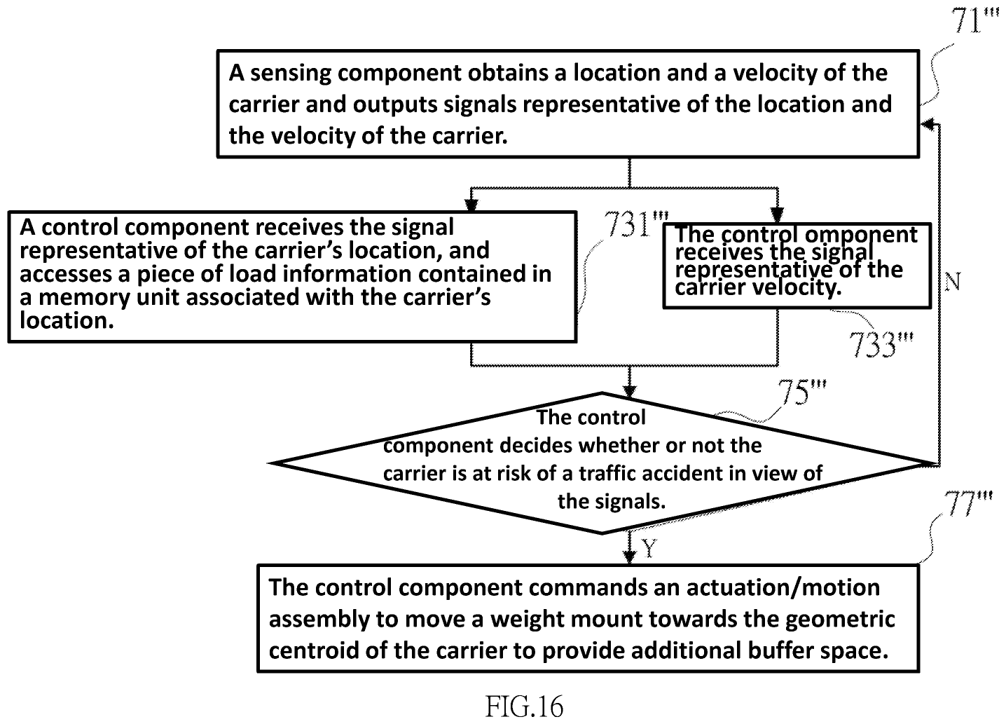

FIG. 16 shows a flowchart to illustrate an application of the automatic displacement device according to the fourth embodiment. In step 71′″, the sensor 151′″ measures a velocity of the carrier 9′″ (through the lidar sensing unit), and determines a location of the carrier 9′″ (through the GPS receiver). In step 731′″, the controller 153′″ receives the carrier location signal from the GPS receiver, and accesses a piece of road information in the memory unit 169′″ associated with the carrier location. In step 733′″, the controller 153′″ receives the carrier velocity signal from the lidar sensing unit. In step 75′″, the controller 153′″ decides whether or not the carrier 9′″ is at risk of an impact or rollover; if yes, then step 77′″ will be executed, wherein the weight mount 11′″ together with the passengers and the battery pack will be moved towards the geometric centroid of the carrier's body 91′″ so as to provide additional buffer space, thus increasing the protection effect of the buffer component 113′″.

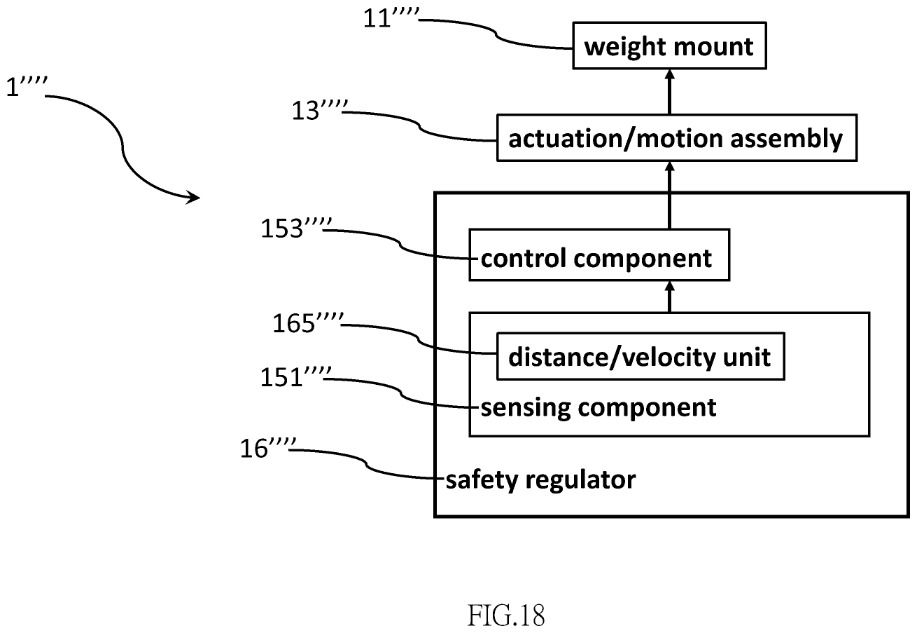

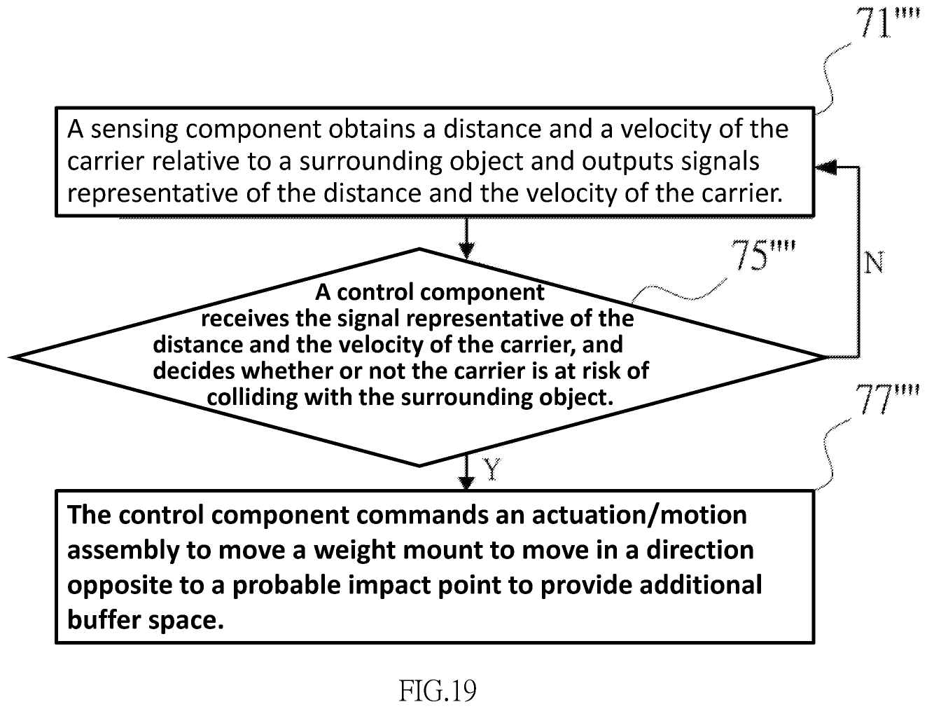

FIG. 17 through 19 show a fifth embodiment of the present invention, wherein the carrier 9′″ is a small truck usually serving in a supply network, and the automatic displacement device 1″″ is implemented in the small truck. The actuator 13″″ includes a plurality of longitudinal rails and a plurality of transverse rails on the bed of the truck's body 91′″. The weight mount 11″″ is fixed on the actuator 13′″. The weight mount 11″″ includes a support component 111″″, which refers to a cargo container, and a buffer component 113″″, which refers to shock absorbers disposed between goods (heavy object 92′″) in the container.

The safety regulator 16″″ includes a sensor 151″″ and a controller 153′″. The sensor 151″″ includes a distance/velocity measurement unit 165″″, such as a radar sensing unit. FIG. 19 shows a flowchart to illustrate an application of the automatic displacement device according to the fifth embodiment. In step 71″″, the distance/velocity measurement unit 165′″ measures motion states of the carrier 9′″, including a distance between the carrier 9′″ and a surrounding object, such as a tree, and a velocity of the carrier 9′″ relative to the surrounding object. In step 75″″, the controller 153″″ receives the motion states of the carrier 9′″ from the sensor 151″″, and decides whether or not the carrier 9′″ is at risk of colliding with the surrounding object; if yes, then step 77′″ will be executed, wherein the weight mount 11″″ together with the heavy objects 92′″ thereon will be moved in a direction opposite to the surrounding object so as to provide additional buffer space, thus reducing possible damages. Of course, those skilled in the art can understand that damages in more complicated traffic accidents involving impacts or rollovers can also be reduced by increasing buffer space for objects desired to be protected.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the scope of the invention.

What is claimed is:

1. An automatic displacement device for use in a carrier having a body that accommodates at least one heavy object, comprising:
at least one weight mount for holding the heavy object;
at least one actuator coupled to the weight mount;
a stability regulator electrically communicated to the actuator, including:
a sensor capable of measuring a state associated with an angle of the carrier's body and outputting a signal representative of the state, the sensor including a plurality of force-measuring elements to measure weight distribution of the body; and
a controller capable of calculating a tilt of the carrier according to the signal outputted from the sensor, and capable of commanding the actuator to move the weight mount in view of the tilt, so as to shift the gravity center of the heavy object and thus perform a compensation on the carrier.

2. The automatic displacement device of claim 1, wherein the sensor includes an inertial sensing unit located at the carrier's body.

3. The automatic displacement device of claim 1, wherein the carrier is provided with a plurality of wheels supporting the carrier's body; the sensor includes a plurality of force-measuring elements provided at the wheels.

4. The automatic displacement device of claim 1, wherein the sensor includes a position determination unit to obtain a location of the carrier, and the controller includes a memory unit containing road information, whereby when the carrier is about to change direction, the controller commands the actuator to move the weight mount to facilitate the carrier to corner.

5. The automatic displacement device of claim 1, wherein the weight mount includes:
at least one support component for bearing the weight of the heavy object; and
a buffer component horizontally disposed between the heavy object and the support component.

6. In a method for controlling an automatic displacement device used in a carrier having a body that accommodates at least one heavy object, wherein the automatic displacement includes at least one weight mount capable of holding the heavy object, at least one actuator coupled to the weight mount, and a stability regulator including at least one sensor and at least one controller capable of commanding the actuator to move the weight mount in response to a change of road condition, the sensor including a position determination unit and a plurality of force-measuring elements to measure weight distribution of the body, the controller including a memory unit containing road information; the method comprising:
(a) configuring the sensor to measure a state associated with an angle of the carrier and to output a signal representative of the state;
(b) configuring the controller to calculate a tilt of the carrier according to the signal outputted from the sensor and to issue a command in view of the calculated tilt to the actuator; and
(c) configuring the actuator to move the weight mount according to the command issued by the controller so as to shift the gravity center of the heavy object and thus perform a compensation on the carrier.

7. The method of claim 6, wherein;
in step (b), the controller is further configured to receive a signal representative of a carrier's location measured by the position determination unit, and to access a piece of road information in the memory unit associated with the carrier's location; and
in step (c), when the carrier is about to corner, the controller issues a command to the actuator to move the weight mount in view of the calculated tilt and the associated road information, to facilitate the carrier to corner.

8. An automatic displacement device for use in a carrier having a body that accommodates at least one heavy object, comprising:
at least one weight mount for holding the heavy object;
at least one actuator coupled to the weight mount;
at least one safety regulator electrically communicated to the actuator, the safety regulator including:
at least one sensor for measuring motion states of the carrier relative to surrounding objects and outputting signals representative of the motion states; and
at least one controller configured to receive the signals outputted from the sensor; if the carrier is at risk of a traffic accident, the controller issues a command to the actuator to move the heavy object away from an estimated impact point and thus provide additional buffer space for the heavy object.

9. The automatic displacement device of claim 8, wherein the sensor includes at least one distance/velocity measurement unit.

10. The automatic displacement device of claim 9, wherein the distance/velocity measurement unit employs a technique of optical emission/return measurement.

11. The automatic displacement device of claim 9, wherein the sensor further includes a position determination unit for determining a location of the carrier, and the controller includes a memory unit containing road information.

12. The automatic displacement device of claim 8, wherein the weight mount includes:
at least one support component for bearing the weight of the heavy object; and
a buffer component horizontally disposed between the heavy object and the support component.

13. In a method for controlling an automatic displacement device used in a carrier having a body that accommodates at least one heavy object, wherein the automatic displacement includes at least one weight mount for holding the heavy object, at least one actuator coupled to the weight mount, and a stability regulator including at least one sensor and at least one controller capable of commanding the actuator to move the weight mount so as to provide a buffer protection for the weight object, the sensor including a position determination unit and a distance/velocity measurement unit, the controller including a memory unit containing road information; the method comprising:
(a) configuring the sensor to measure at least one motion state of the carrier relative to a surrounding object and to output a signal representative of the motion state;
(b) configuring the controller to receive the signal outputted from the sensor; if the carrier is at risk of a traffic accident, the controller issues a command to the actuator; and
(c) configuring the actuator to move the weight mount according to the command so as to move the heavy object away from an estimated impact point and thus provide a buffer protection for the heavy object.

14. The method of claim 13, wherein:
in step (a), the motion state of the carrier include a velocity of the carrier; and the sensor is further configured to obtain a location of the carrier;
in step (b), the controller is further configured to receive a signal representative of the carrier location and to access a piece of road information in the memory unit associated with the carrier location;
in step (c), when the carrier is at risk of a rollover accident, the controller issues a command to the actuator to move the weight mount together with heavy object towards the geometric centroid of the carrier's body so as to provide a buffer protection for the heavy object.

15. The method of claim 13, wherein:
in step (a), the motion state of the carrier includes a velocity and a distance of the carrier's body relative to the surrounding object;
in step (b); the controller decides whether or not the carrier is at risk of colliding with the surrounding object; and
in step (c), the actuator moves the weight mount together with the heavy object in a direction opposite to the surrounding object.
